(19) United States
(12) Patent Application Publication
(10) Pub. No.: US 2010/0274750 A1
(43) Pub. Date: Oct. 28, 2010

(54) Data Classification Pipeline Including Automatic Classification Rules

(75) Inventors: Paul Adrian Oltean, Redmond, WA (US); Clyde Law, Seattle, WA (US); Judd Hardy, Issaquah, WA (US); Nir Ben-Zvi, Redmond, WA (US); Ran Kalach, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/427,755

(22) Filed: Apr. 22, 2009

(51) Int. Cl. G06N 5/02

(52) U.S. Cl. 706/47; 706/46

(57) ABSTRACT

Described is a technology in which data items (e.g., files) are processed through an extensible data processing pipeline, including a classification pipeline, to facilitate management of the data items based upon their classifications. A discovery module locates data items to process. An independent classification pipeline obtains metadata (properties) associated with each discovered data item, and one or more classifiers classify the data item based on the metadata. An independent policy module applies policy to each data item based upon its classification. Multiple classifiers may be invoked, based upon various criteria. Predefined ordering of the classifiers, authoritative classifiers and/or an aggregation mechanism handle any classification conflicts. Different types of classifiers may be provided, and each classifier may correspond to automatic classification rules; the classifier may directly change a property, (e.g., set the classification) or return a result to a corresponding rule mechanism for changing a property.

### BACKGROUND

The amount of data maintained and processed in a typical enterprise environment is enormous and rapidly increasing. For example, it is typical for information technology (IT) departments to have to deal with many millions or even billions of files, in dozens of formats. Moreover, the existing number tends to grow at a significant (e.g., double-digit yearly growth) rate. Most of this data is not actively managed, and is kept in unstructured form in file shares.

Existing data management tools and practices are not very capable in keeping up with the various and complex scenarios that may be present. Such scenarios include compliance, security, and storage, and apply to unstructured data (e.g., files), semi-structured data (e.g., files plus extra properties/metadata) and structured data (e.g., in databases). Any technology that reduces management costs and risks is thus desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which data items (e.g., files) are processed through a data processing pipeline, including a classification pipeline, to facilitate management of the data items based upon their classifications. In one aspect, a classification pipeline obtains metadata (e.g., business impact, privacy level and so forth) associated with each discovered data item. A set of one or more classifiers classify the data item, if invoked, into classification metadata (e.g., one or more properties), which are then associated (saved in association) with the data item. Policy then may be applied to each data item based upon its associated classification metadata, e.g., to expire a file, change a file's protection/access level, and so forth, based upon each file's metadata.

In one aspect, the data item processing pipeline includes modular components for independent phases of item discovery, classification and policy application. Each phase is extensible and can include one or more modules (or none) that function in that phase. Classification metadata/properties of each item may be externally set or obtained via a set or get interface, respectively.

In one aspect, in the classification phase, multiple classifier modules may be invoked. A decision may be made whether to invoke each classifier based upon various criteria, such as whether and/or when a data item has been previously classified. The classifier may use any of the properties associated with a data item, and/or the content of the data item itself, in classifying the data item. Predefined ordering of the classifiers, authoritative classifiers and/or an aggregation mechanism are among techniques that may be used to handle any conflicts as to how different classifiers classify the same item.

Different types of classifiers may be provided, including a classifier that classifies a data item based upon a location of the data item, a global repository-based classifier (based on owner and/or author), and/or a content-based classifier that classifies an item based upon content contained within the item. Each classifier may correspond to automatic classification rules; the classifier may directly change a property value, or return a result to a corresponding rule mechanism such that the corresponding rule mechanism may change a property.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example modules in a pipeline service for automatically processing data items for data management, including discovering data items, classifying those data items, and applying policy based upon the classification.

FIG. 2 is a representation showing example steps performed by the pipeline service when processing files of a file server into properties associated with the files.

FIG. 3 is a representation of an example classification service architecture exemplifying how properties of a data item may be passed among modules for processing via a classification runtime.

FIGS. 4A and 4B comprise a flow diagram showing example steps taken to process data items, including steps to classify items for policy application.

FIG. 5 shows an illustrative example of a computing environment into which various aspects of the present invention may be incorporated.

### DETAILED DESCRIPTION

Various aspects of the technology described herein are generally directed towards managing data (e.g., files on file servers or the like) by classifying data items (objects) into a classification, and applying data management policies based on the classification. In one aspect, this is accomplished via a modular approach for data classification-enabled solutions, based upon a classification pipeline. In general, the pipeline comprises a succession of modular software components that communicate through a common interface. At various points in time, data is discovered and classified, with policy applied to the data based on the data classification.

While various examples are used herein, such as different file classification types for classifying files/data maintained on a file server, it should be understood that any of the examples described herein are non-limiting examples. For example, not only may files be classified, but other data structures may also be classified into related classification “types,” e.g., any data that is structured (e.g., any piece of data that follows an abstract model describing how the data is represented and can be accessed) may be classified, e.g., email items, database tables, network data and so forth. Further, other ways of storing data may be used, e.g., instead of, or in addition to, a file server, data may be maintained in local storage, distributed storage, storage area networks, Internet storage, and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data management in general.

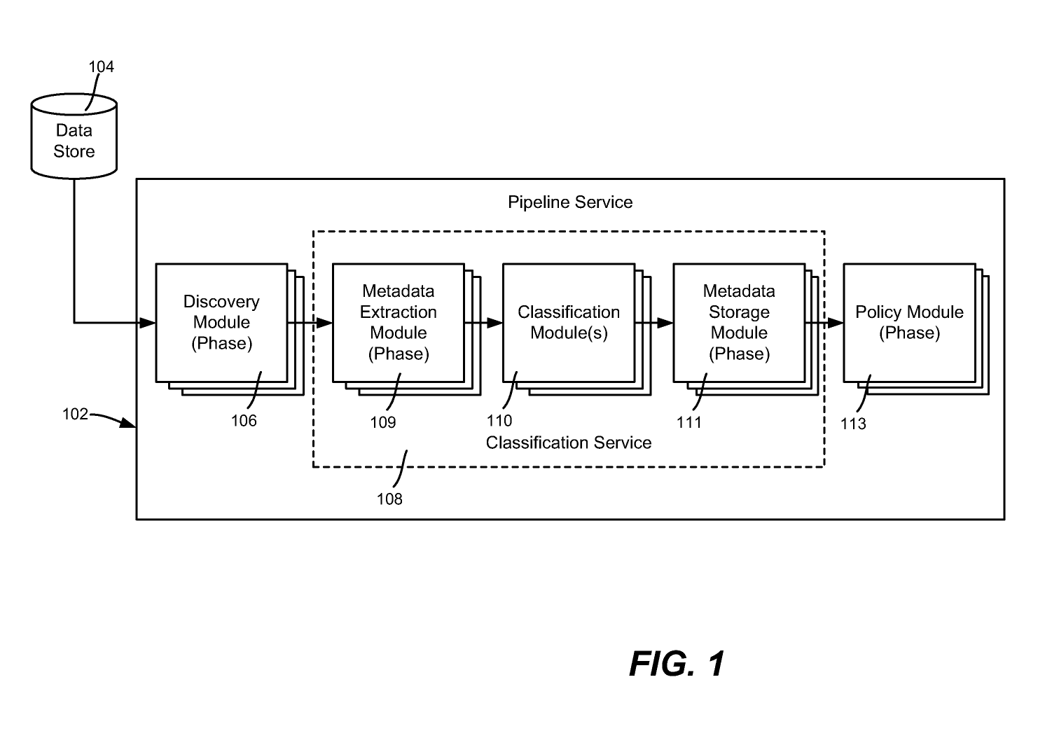

FIG. 1 shows various aspects related to the technology described herein, including a pipeline for processing data items, which as exemplified herein may be used to process files, but as is understood may be used to process one or more other data structures, such as email items. In the example of FIG. 1, the pipeline is implemented as a service 102 that operates on any set of data as represented by the data store 104.

In general, the pipeline service 102 includes a discovery module 106, a classification service 108, and a policy module 113. Note that the term “service” is not necessarily associated with a single machine, but instead is a mechanism that coordinates a certain execution of a pipeline. In this example, the classification service 108 includes other modules, namely a metadata extraction module (or modules) 109, a classification module (or modules) 110, and a metadata storage module (or modules) 111. Each of the modules, described below, may be thought of as a phase, and indeed, the timeline for each of the operations need not be contiguous, i.e., each phase may be performed relatively independently and need not immediately follow the previous phase. For example, the discovery phase may discover and maintain items that the classification phase later classifies. As another example, data may be classified on a daily basis, with a data management application (e.g., backup) run once a week. Any of the phases may be independently performed, in real time online processing or offline processing, in a foreground or in a background (e.g., lazy) operation, or in a distributed manner on separate machines.

In general, the discovery module (or modules) 106 finds items to classify (e.g., files), and may use more than one mechanism to do so. By way of example, there may be two ways to discover files on a file server, one that operates by scanning the file system, and another that detects new modifications to files from a remote file access protocol. In general, the discovered data is provided as items to the classification phase/service 108 for classifying, whether directly or via an intermediate storage. In this way, discovery may be logically detached from classification.

Discovery may be initiated in a number of ways. One way is on demand, in which items are discovered following a request. Another way is real time, where a change to one or more items triggers the discovery operation. Yet another way is scheduled discovery, e.g., once a day, such as after normal working hours. Still another way is lazy discovery, in which a background process or the like operates at a low priority to discover items, e.g., when network or server utilization is relatively low. Further, note that discovery may be run in an online operation, that is, on the real data, or on an offline copy of the data such as a point-in-time snapshot of the original data; (note that in general a snapshot copy refers to a copy of the particular data items as they were at some defined point in time, whereby working on a snapshot copy helps to maintain the data items in a constant state as they are being processed, in contrast to a live system in which data items may change in real time).

Following the classification phase/service 108 (described below), the policy module (or modules) 113 applies policy based on each item's classification. By way of example, an information leakage protection product may classify certain files as having “Personal Identifiable Information” or the like. A file backup product may be configured with a policy such that any file classified as having “Personal Identifiable Information” is to be backed up to an encrypted storage.

Turning to various aspects related to classification, as represented in FIG. 1 the metadata extraction module (or modules) 109 finds metadata associated with the data items. For example, the file system has many attributes that it associates with a file, and these may be extracted in a known manner. The metadata extraction module (or modules) 109 also extract the current values of the classification metadata so that it can be used as input to the classification phase. Note that classification may be run on live data or backup data.

Some examples of metadata include classification property definitions having various elements such as a property name (or identifier), a property value type (which identifies the data type of the actual value, e.g., simple data types such as string, date, Boolean, ordered set or multi-set of values) and complex data types such as data types described by a hierarchical taxonomy (document type, organizational unit, or geographical location). A classification property value (called “property value” or simply “property”) is a certain value that may be assigned to a data item with the purpose of classifying that data item. This value is associated with a classification property, and generally respects the restrictions imposed by the associated property definition.

Other examples include a property schema (describing more restrictions on the possible values), and an aggregation policy describing how multiple values could be aggregated in a single one, in the case we need such aggregation during pipeline execution. Still further, metadata may comprise additional attributes associated with the properties, such as language-dependent information, extra identifiers, and so forth.

By way of an example, consider a property named “Business impact”, of type “ordered value set,” which is restricted to values HBI (high business impact), MBI (medium business impact) and LBI (low business impact), with the aggregation policy that the HBI wins over MBI which wins over LBI. Note that in the classification process, the association of a property value to a data item will automatically “bind” that document to a class (i.e., category) of documents. For example, by attaching the property BusinessImpact=HBI” to a data item, this data item is implicitly assigned to the “category” of documents BusinessImpact=HBI”.

Metadata may also be maintained in an external data source or other cache. One example includes allowing users, or clients, and/or one or more other mechanisms to set the classification metadata, or the classification itself, and maintain it in a data store such as a database. Thus, for example, a user may manually set a file as containing “Personal Identifiable Information” or the like. An automated process may perform a similar operation, such as by determining metadata based on what folder contains the file, e.g., a process may automatically set associated metadata for a file when that file is added to a sensitive folder.

Further, metadata for an item may be maintained (cached) from a previous extraction and/or classification operation. Thus, metadata extraction may be in multiple parts, e.g., extract existing metadata (retrieval) and extract new metadata. As can be readily appreciated, retrieving existing metadata may increase classification efficiency, such as for files that seldom change. Still further, an efficiency mechanism may determine whether to call a classifier based on the last time that the classifier metadata was up to date, e.g., based on a timestamp received from the classifier. A change in the configuration of the classification service 108, such as a rule change or classifier change, may also trigger a new classification.

Once the metadata is obtained for an item, the classification module or modules 110 classifies the item based upon its metadata. The item's content may also be evaluated, e.g., to look for certain keywords, (e.g., “confidential”), tags or other indicators as to a property of a file that may be used to classify it. There are various ways to classify data. For example, when classifying files, a file may have been manually set by a user for classification, and/or classified by a line of business (LOB) application (e.g., a human resources application) that controls the file. A file may be set for classification by running administrator scripts, and/or automatically classified using a set of classification rules.

In general, automatic classification rules provide a generic, extensible mechanism that is part of the classification pipeline phase 108. This allows an administrator or the like to define the automatic classification rules that are applied to data items to classify those items. Each automatic classification rule activates a classification module (classifier) that can determine the classification of a certain set of data objects and set classification properties. Note that one classifier module may include several rules to determine different classification properties for the same data item (or to different data items). Further, multiple classifiers may be applied to the same data item; e.g., two different classifiers may each determine whether a file has “Personal Identifiable Information.” Both classifiers may be deployed to evaluate the same file, whereby even if only one classifier determines that a file contains “Personal Identifiable Information,” the file is classified as such.

By way of example, some elements that a rule may contain include rule management information (rule name, identifiers, and so forth), rule scope (a description of the set of the data items to be managed by the rule, such as “all files in c:\folder1”), and rule evaluation options describing how the rule is executed during the pipeline. Other elements include a classifier module (a reference to the classifier used by this rule to actually assign the property value), property (an optional description defining the set of properties assigned by this rule), and additional rule parameters such as additional execution policies (such as additional filters like regular expressions used to classify the content of the file, and the like).

Example classifier modules include (1) a classifier that classifies items based on the data item's location (e.g., file directory), (2) a classifier that classifies by using a global repository based on some characteristic of the data item (e.g., lookup the organizational unit in Active Directory®, or AD, based on the file owner), and (3) a classifier that classifies based on data content and data characteristics (e.g., look for a pattern in the item's data). Note that these are only examples, and those skilled in the art may recognize that other characteristics of the items may also be used to classify different items, i.e., virtually any relative difference among items may be used for classification purposes.

In one implementation, a classifier may operate in various modes. For example, one “explicit classifier” operating mode has the classifier set the actual property or properties, e.g., when personal information is found in a file, the classifier sets a corresponding property “PII” to “Exists” or the like. Another suitable mode is “non-explicit classifier,” which may have a classifier return TRUE or FALSE, e.g., as to whether a file is in a certain directory such as c:\debugger. In a TRUE or FALSE mode, the automatic classification rule is associated with the property and value that is to be set whenever the classifier returns TRUE. Thus, the classifier may set the property value or values, or a rule that invokes a classifier may do so. Note that classifiers other than TRUE or FALSE types may be employed, e.g., one that returns a numeric value (e.g., a probability value) to provide more granular classification and classification rules.

Following classification, the classification result, and possibly other extracted metadata, is optionally saved in association with the item. As represented in FIG. 1, the metadata storage module 111 performs this operation. Storage allows policy to be applied based upon the classification at a later time.

Note that each of the classification pipeline modules is extensible so that various enterprises may customize a given implementation. The extensibility allows more than one module to be plugged into the same phase of the pipeline. Further, any of the phases may be performed in parallel, or in sequence, e.g., in a distributed manner (across multiple machines). For example, if classification is computationally expensive, then items can be distributed (e.g., using load balancing techniques) to parallel sets of classifiers running on different machines, with the results of each parallel path provided to the policy module.

With respect to policy, applications (including those not directly plugged into the pipeline) may evaluate the classification metadata in order to make policy decisions on how to handle the item. Such applications include those that perform operations to check for item expiration, auditing, backup, retention, search, security, compliance, optimization, and so forth. Note that any such pending operation may trigger a classification of the data in the event that the data is not yet classified, or not classified with respect to the pending operation.

As can be readily appreciated, different classifiers may result in different and possibly conflicting classifications. In one aspect, aggregation of classification values for properties is performed. To this end, for each data item, the defined classification rules are evaluated (e.g., by an administrator or process) to determine the classification properties. If two classification rules are able to set the same value for one specific classification property, an aggregation process determines the final value of the classification property. Thus, for example, if one rule causes a result where a property is set to “1” and the other rule causes a result where that same property would be set to “2”, then the defined aggregation policy, may, in some embodiments, determine what the actual value for that property should be, i.e., “1” or “2” or something else. Note that in this particular scenario, one rule does not overwrite another rule's property setting, but instead the aggregation policy is invoked to manage the conflict.

In another scenario, authoritative classifiers may be used. Authoritative classifiers are another type of classifier, which in general are classifiers that can override other classifiers, without activating aggregation rules. Such a classifier can flag its result, for example, so that it wins any conflicts.

In another aspect, a mechanism is provided for automatically determining the evaluation order for classification rules. To this end, the rule evaluation order may be determined by an administrator, and/or determined automatically by determining any dependencies between the different rules and Classifiers. For example, if a Rule-R1 sets the classification property Property-P1, and Rule-R2 uses a Classifier-C1 that uses Property-P1 to determine the value of Property-P2, then Rule-R1 needs to be evaluated before Rule-R2.

Further, whether to run a classifier may be contingent on the result of a previous classifier. Thus, for example, one classifier may be used that rarely has false positives, and whenever “TRUE” has its result used. A secondary classifier (e.g., designed to eliminate false negatives) is only considered if the authoritative classifier does not return “TRUE”, (e.g., returns “FALSE” or possibly a result indicating uncertainty). Another example is to have certain classifiers be ordered in the pipeline based on a predefined “altitude”. For example a lower-altitude classifier is executed in the pipeline before a higher altitude classifier. Therefore, in a pipeline, classifiers are sorted by an increasing order of altitude.

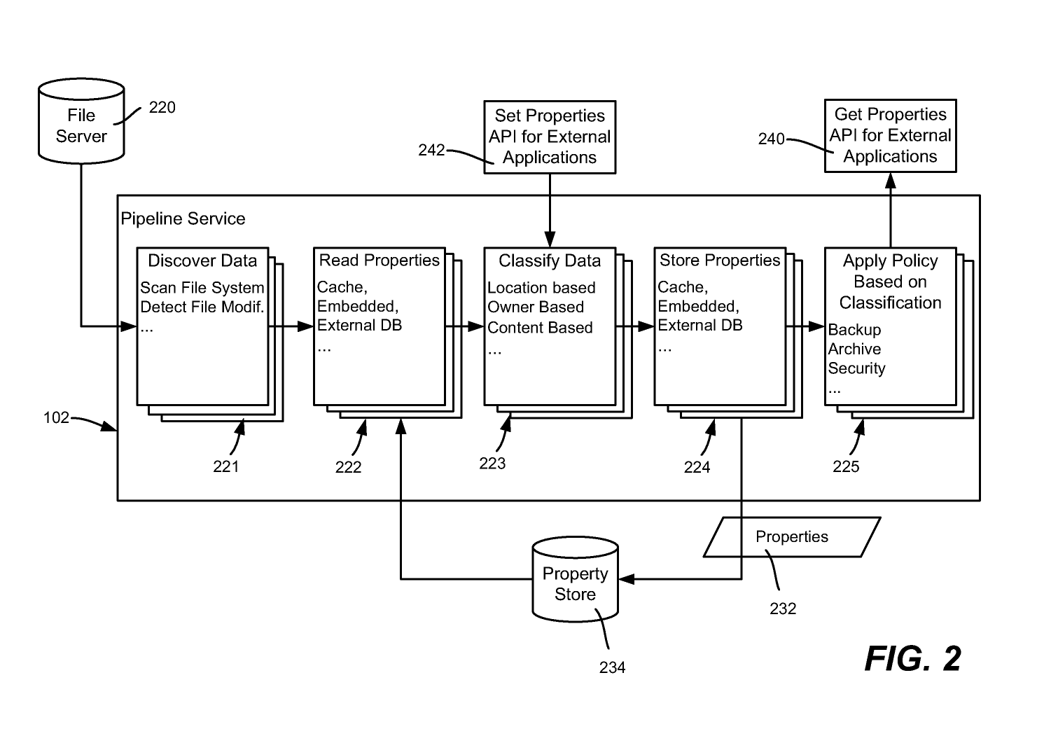

FIG. 2 shows a more specific example directed towards implementing extensible automatic classification rules on a file server 220. In general, instead of modules, FIG. 2 represents the various steps 221-225 of the pipeline service; as can be seen, these steps/modules 221-225 correspond to the modules 106, 109-111 and 113 of FIG. 1, respectively. Thus, the classification rules are applied within the classification pipeline, and includes one or more data discovery modules 221 (e.g., scanners), one or more metadata read modules 222 (e.g., extractors and retrievers), a set of one or more modules 223 that determine classification (classifiers), one or more modules 224 that store the metadata (setters) and one or more modules 225 that apply policy based on the classification (policy modules).

As also represented in FIG. 2, the number of modules at any given step may be extended. For example, the classification steps provide an extensibility model for classifiers; administrators can register new classifiers, enumerate existing classifiers and unregister classifiers that are no longer desirable.

As generally described herein, the steps for managing files on file servers include classifying the files, and applying data management policies based on each file's classification. Note that a file may be classified such that no policy is applied to it.

In one implementation, the automatic classification process for files on a file server 220 is driven by classification rules defined on that server 220. When a file is stored on a file server in which classification is active, it is classified automatically, i.e., there is no explicit request from a user to classify the file. Various classification criteria that may be used to classify the file on that particular file server include (1) the classification rules and classifiers running on the file server, (2) any previous classification results that remain associated with the file, and/or (3) the properties that are stored in the file (or its attributes) itself. These criteria are evaluated when determining the classification of a given file to provide a resultant set of properties 232, which are stored in a property store 234 (but may be stored in the file itself).

In one implementation, each classification rule may have evaluation options such as those set forth below:
Evaluate only if the file has not been classified yet;
Evaluate even if the file has been already classified, and take the previous classification property value or values (e.g., from previous runs of the classification process on the same file, if exists) into account;
Evaluate even if the file has been already classified, but do not take any previous classification property value into account.

By way of example, consider a document (with no properties assigned) saved by a user as a file to a folder on a server. An automatic classification rule classifies the file as having medium business impact, that is, BusinessImpact=MBI. This classification may be also stored inside the document (because the file server has a parser installed for this type of document).

Consider that the document is then copied to another server (and a different folder). The new folder falls into a classification rule that if run, classifies files in the folder as having high business impact BusinessImpact=HBI if the file is not already classified. However, because the properties within this file indicate that the BusinessImpact classification is already set to MBI, the file BusinessImpact property remains MBI.

The above rule may be modified so as to evaluate the file even if the file is already classified, and may or may not take into account the property value in the file. In a subsequent classification run, the rule is evaluated, and because HBI is higher than MBI, the aggregation policy determines that the file property is to be set to HBI.

As can be seen, each classification rule relies on the classifier that is used for that rule. By way of another example, consider a classification rule that contains <scope>, <classifier>, <classification property>, <value>, in which the classifier contains a specific implementation that is used to classify a file. For example, a “classify by folder” classifier enables classification of files by their location. This classifier looks at the current path of the file and matches it with the path specified in the <scope> of the classification rule. If the path is within the <scope>, then the rule indicates that the <classification property> can have the <value> specified in the rule; (the property is not necessarily set, because multiple rules may need to be aggregated to determine what the actual value is for this classification property). Note that this is an explicit classifier, as it requires that the <value> is specified.

As an example of a different type of file classifier, a “Retrieve classification from AD by owner” classifier reads the owner of the file and queries the active directory to figure out what is the right value by owner for the <classification property> that is mentioned in the rule. Note that this is a non-explicit classifier, as it determines the <value>; thus the <value> is not to be specified in the rule.

Each classifier may optionally indicate which properties it uses for the classification logic. This information is useful in determining the order in which the classification process invokes the classifiers, as well as to indicate which properties need to be retrieved from the store 234 prior to calling the classifiers.

In addition, each classifier may optionally indicate which properties it is used for setting. This information may be used in a user interface to show which properties are relevant for this classifier (if none are mentioned, then all properties are relevant), as well as in the classification process where this information indicates which properties are to be retrieved from the store prior to calling the classifiers. The information is relevant for explicit and non-explicit classifiers. For example: the “Classify by folder” explicit classifier does not have specific properties indicated, nor does the “Retrieve classification from AD by owner” non-explicit classifier. However, a “Determine organizational unit” non-explicit classifier only knows how to set an “Organizational Unit” property.

For additional identification, optional information may be used to describe the classifier, such as company name and version labels.

A classifier may also need to consume additional parameters. For example, if a classifier is built to find personal information in a file based on some granular expressions, then those granular expressions need not be hardcoded into the classifier, but rather may be provided from an external source, such as an XML file that is regularly updated. In this case, the classifier includes a pointer to that XML file. A File Server Resource Manager (FSRM)-based classification allows specifying additional parameters for a classifier, with these parameters passed to the classifier as input when it is invoked

Further, the classifier runtime behavior may be different between different classifiers, because of a permission level with which the classifier runs. One permission level is “local service” however a higher or lower permission level may be needed, e.g., “Local system” or “Network service.”

Another aspect is whether the classifier need access the file content. For example, the above-described folder classifier does not need to access the file content, because it classifies based on the containing folder. In contrast, a classifier that identifies specific text or patterns (e.g., credit card numbers) in a file needs to process the file content. Note that a classifier that needs access to the file content does not need to run in an elevated privilege because the FSRM classification streams the file content for the classifier.

The following table summarizes various characteristics of one implementation of a classifier:

Name (unique)
Enabled/Disabled (default - Enabled)
Explicit/Non-explicit
Does the classifier need FSRM classification to stream the file
content for it?
(default: No)
Runtime privilege of the classifier (default: local service)
Properties it uses (optional)
Properties it sets (optional)
Description (optional)
Company name (optional)
Version (optional)
Altitude level
Additional parameters (optional)

FIG. 2 also represents APIs 240, 242 that allow other external applications to get or set the properties for a data item, respectively. In general, the Get Properties API 240 is used to “pull” properties at arbitrary times (in contrast to the pipeline pushing properties to policy modules when it runs). Note that this API 240 is shown after the classification and storage phases 223 and 224, respectively, so as to be able to get any properties that were set during the classify data phase 223.

The Set Properties API 242 is used to “push” properties into the system at arbitrary times, (although note that this API 242 is shown as operating in conjunction with the classify data phase 223 so that properties can be saved later, during the Store Properties phase 224; that is, Set Properties is basically a user-directed manual classification). Further note that as part of the classification process, classifiers may have access to additional predefined file properties that are extracted from the file for the use of classification (e.g., File.CreationTime . . . ). These properties may not be exposed as classification properties through the classification API.

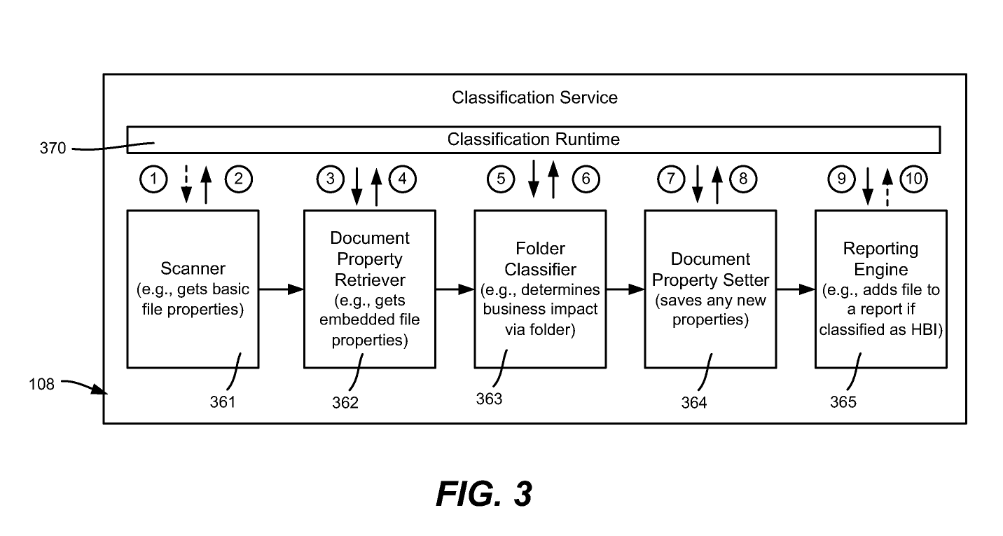

Turning to FIG. 3, one example architecture for a classification service 108 that includes a folder classifier 363 is built by assembling pipeline modules 361-365 that communicate with a classification runtime 370 through a common streaming interface, e.g., via operations labeled one (1) through ten (10); solid arrows represent DCOM calls, for example. In this example, each pipeline module 361-365 processes streams of PropertyBag objects (one property bag per document/file), wherein each PropertyBag object holds the list of properties accumulated from the previous pipeline module (if any). In general, the role of each pipeline module 361-365 is to perform some actions based on these file properties (e.g., add more properties), and pass the same property bag back to the runtime 370. The runtime 370 passes the stream of property bags to the next pipeline module until complete.

In one FSRM-based classification service, pipeline modules are hosted differently depending on sensitivity. More particularly, pipeline modules that do not interpret/parse user content (such as the exemplified “folder” classifier that interprets file system metadata or the “AD” classifier that is directed towards AD properties) may be hosted directly in the FSRM classification service. Pipeline modules that deal with user-provided content and/or third party/external modules (such as parsing Word documents hosted in a low-privileged hosting process, running under a non-administrator user account.

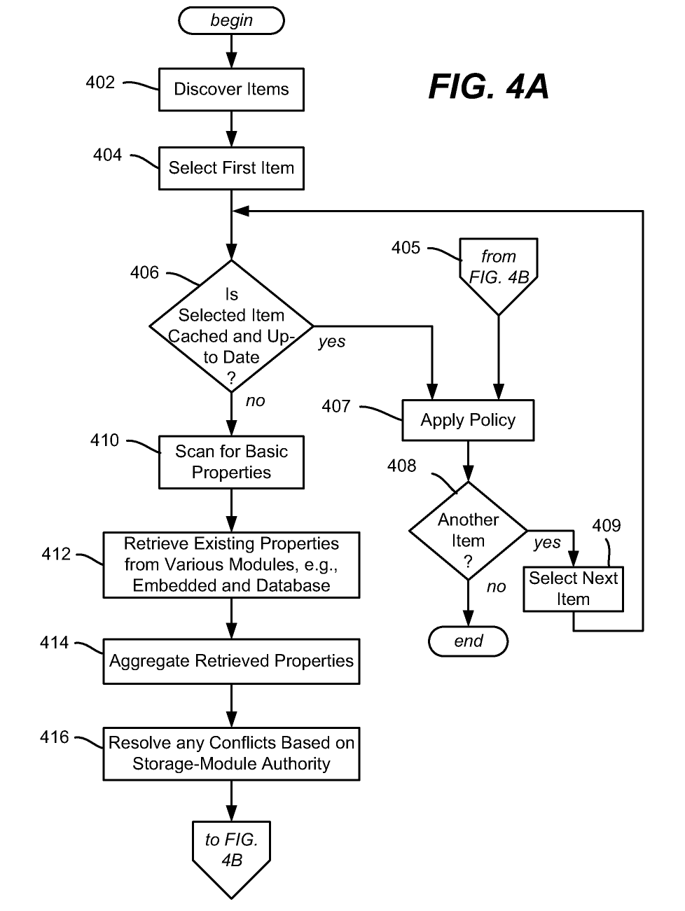

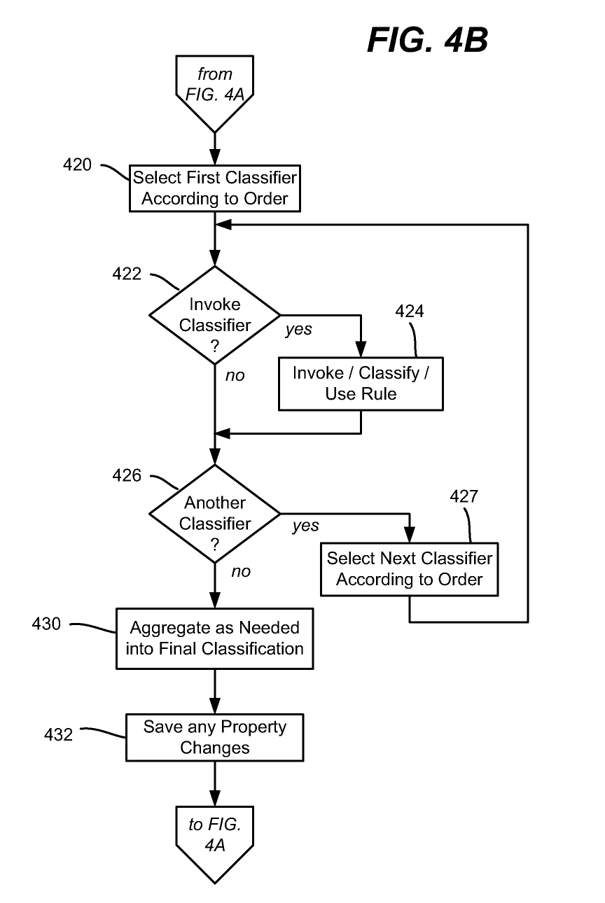

FIGS. 4A and 4B summarize the various pipeline operations by example steps of a flow diagram, beginning at step 402 which represents discovering the items. Step 404, which may operate as step 402 provides each new item or any time after step 402 provides at least one item, selects a first item.

Step 406 evaluates whether the selected item is cached and is up-to-date in the cache. If so, the item need not be processed through the rest of the pipeline, and thus branches to step 407 to apply any policy based upon the properties as desired; note that policy is applied to cached/up-to-date files as appropriate. Steps 408 and 409 which repeat the process for other items until none remain.

If the item is to be processed through the rest of the pipeline, step 406 instead branches to step 410 which represents scanning the item for basic properties of the item. These may be file metadata, embedded properties, and so forth.

Step 412 represents retrieving any existing properties associated with the item. These may be from various storage modules as described above, e.g., embedded and database modules.

Step 414 aggregates the various properties. Note that it is possible properties may conflict, e.g., in an example above, the classification properties of a file may be embedded in a file, and may also be externally associated with a file. A timestamp or other conflict resolution rule may determine a winner, or a classification may be forced if classification is otherwise to be skipped because of a conflicting property value. Step 416 represents resolving any such conflicts, e.g., based upon a storage module authority.

The process continues to step 420 of FIG. 4B, which represents selecting the first classifier based on classifier ordering as described above; (note that there may be only one classifier). Step 422 represents determining whether to invoke the selected classifier. As described above, there are various reasons why a particular classifier may not be run, e.g., based on the existence of a prior classification, based on a timestamp or other criterion, and so forth. If not to be invoked, step 422 branches to step 426 to check whether another classifier is to be considered.

If the selected classifier is to be invoked at step 422, step 424 is performed, which represents invoking the classifier, passing any parameters as described above, which then performs the classification. As also described above, if the classifier does not directly set a property, then the corresponding rule is used based upon the classifier's result.

Steps 426 and 427 repeat the process of steps 422 and 424 for any other classifiers. Each other classifier is selected according to the order of evaluation as dictated by altitude or other ordering techniques.

Step 430 represents aggregating the properties as appropriate based upon the classifications. As described above, this includes handling any conflicts, although aggregation does not apply to the classification results of any authoritative classifier.

Step 432 represents saving the property changes, if any, associated with the file. Note that the policy modules may skip policy application if the properties of a file have not changed. The process may then return to step 405 of FIG. 4A to apply any policy (step 407) select and/process the next item, if any, until none remain.

### Exemplary Operating Environment

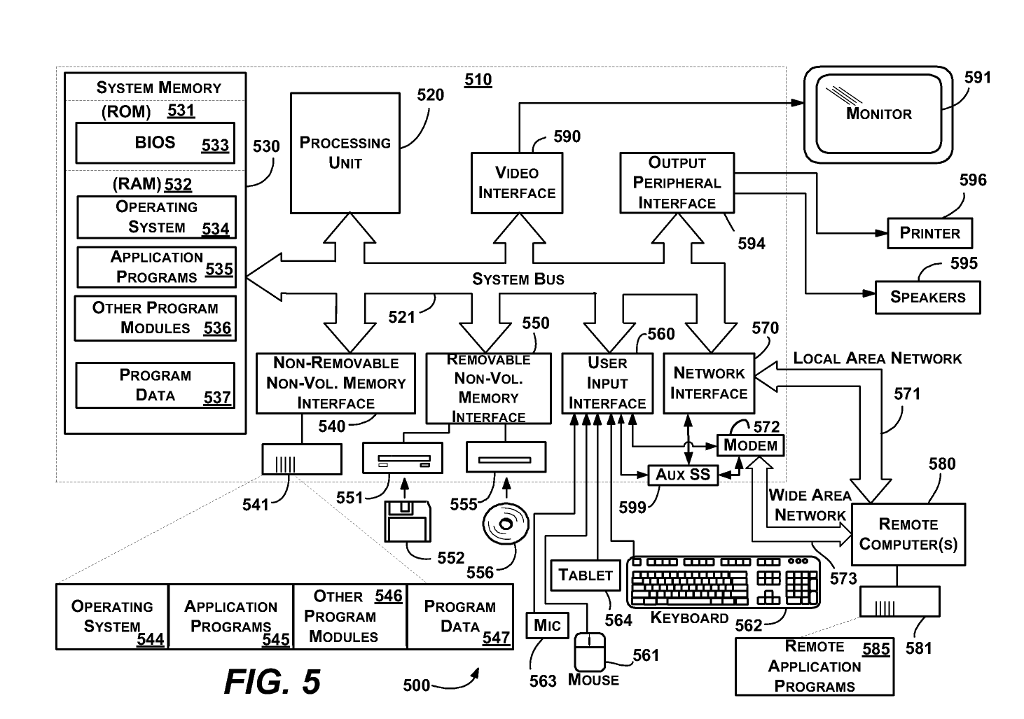

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising, a classification pipeline, including a component that obtains metadata associated with a data item, a set of one or more classifier modules and associated classification rules that each are configured to classify the data item if invoked into classification metadata, and a component that associates the classification metadata with the data item for use in applying policy to the data item.

2. The system of claim 1 wherein the classification pipeline is incorporated into a data item processing pipeline, and wherein the data item processing pipeline includes a discovery module that discovers the data item.

3. The system of claim 2 wherein the data item corresponds to a file, and wherein the discovery module comprises means for scanning a file system to discover files therein, or means for detecting changes to a file.

4. The system of claim 1 wherein the classification pipeline is incorporated into a data item processing pipeline, and wherein the data item processing pipeline includes a policy module that evaluates the classification metadata to apply policy to the data item.

5. The system of claim 1 further comprising means for determining whether to invoke a classifier module based upon any existing classification data, or based upon a timestamp or other identifiers that indicate prior changes to the data file.

6. The system of claim 1 further comprising, an interface for interacting with the classification pipeline to externally set classification metadata.

7. The system of claim 1 further comprising an interface for interacting with the classification pipeline to externally get classification metadata.

8. The system of claim 1 wherein the component that obtains metadata associated with a discovered data item is extensible or replaceable or both extensible and replaceable, wherein each classifier module is extensible or replaceable or both extensible and replaceable, and wherein the component that associates the classification metadata is extensible or replaceable or both extensible and replaceable.

9. The system of claim 1 wherein the classifier set includes a classifier that returns a true or false result, or a classifier that explicitly sets at least one property value corresponding to the classification metadata, or both a classifier that returns a true or false result and a classifier that explicitly sets at least one property value corresponding to the classification metadata.

10. The system of claim 1 wherein the classifier set includes a classifier that classifies a data item based upon a location of the data item, a global repository-based classifier, or a content-based classifier that classifies an item based upon content contained within the item, or any combination of a classifier that classifies a data item based upon a location of the data item, a global repository-based classifier, or a content-based classifier that classifies an item based upon content contained within the item.

11. The system of claim 1 wherein the classifier set includes an authoritative classifier that overrides classification metadata of another classifier in the classifier set, and wherein the classification pipeline includes means for aggregating different classification results from different classifiers of the classifier set into the classification metadata.

12. In a computing environment, a method comprising:
in a first phase, discovering a data item;
in a second phase that is independent of the first phase, using properties associated with the data item to classify the data item, and storing a classification property set comprising at least one classification property in association with the data item; and
in a third phase that is independent of the second phase, applying policy to the data item based upon the classification property set.

13. The method of claim 12 wherein using properties associated with the data item to classify the data item includes automatically apply classification rules using a classification result from a classifier set comprising at least one classifier.

14. The method of claim 12 wherein using properties associated with the data item to classify the data item comprises invoking a plurality of classifiers, and further comprising, receiving a plurality of property sets from the plurality of classifiers, and aggregating the plurality of property sets into the classification property set used for applying policy.

15. The method of claim 12 wherein using properties associated with the data item to classify the data item comprises invoking a plurality of classifiers in a predefined ordering, including passing a property set from one classifier to another classifier for use in classification.

16. The method of claim 12 wherein using properties associated with the data item to classify the data item comprises invoking a plurality of classifiers in a predefined ordering, including allowing a subsequent classifier in the ordering to change the property set of a prior classifier in the ordering.

17. The method of claim 12 wherein using properties associated with the data item to classify the data item comprises determining whether to invoke a classifier based upon whether the data item is already classified, or using at least part of a prior classification property set in reclassifying the data item.

18. One or more computer-readable media having computer-executable instructions, which when executed perform steps, comprising:
discovering data items;
obtaining a property set of properties associated with the data item;
determining whether to invoke each classifier of a classifier set, and if so, invoking the classifier;
updating the property set based on any changes produced by any classifier; and
applying policy to the data item based upon the property set.

19. The one or more computer-readable media of claim 18 wherein obtaining the property set comprises extracting metadata corresponding to the data item, or locating an existing property set associated with the data item, or both extracting metadata corresponding to the data item and locating an existing property set associated with the data item.

20. The one or more computer-readable media of claim 18 wherein updating the property set based on any changes produced by any classifier comprises having a classifier directly update the property set, or having a rule mechanism update the property set based upon a result provided from the classifier.
